(19) United States
(12) Patent Application Publication
(10) Pub. No.: US 2006/0151260 A1
(43) Pub. Date: Jul. 13, 2006

(54) Electric park brake

(76) Inventors: David B. Drennen, Bellbrook, OH (US); Ronald G. Smith, New Carlisle, OH (US); Ernest R. Siler, Springboro, OH (US); Paul Rymoff, Bellbrook, OH (US); Harald Klode, Centerville, OH (US)

Correspondence Address: Delphi Technologies, Inc.;M/C 480-410-202, P.O. Box 5052, Troy, MI, 48007-5052, US

(21) Appl. No.: 11/313,600

(22) Filed: Dec. 21, 2005

Related U.S. Application Data
(60) Provisional application No. 60/641,407, filed on Jan. 5, 2005.

(51) Int. Cl. F16D 55/08; F16D 65/36

(52) U.S. Cl. 188/72.1; 188/157

(57) ABSTRACT

A brake apparatus is provided and includes a housing having a bore extending therethrough and an axial opening therein, a piston closely and slidably received within the bore, a driving member having a flange thereon, the driving member extending through the axial opening to operatively connected the piston to an electric motor, wherein rotation of the driving member is translated into axial movement of the piston, and a bearing coaxially received over the driving member and positioned between the flange and the housing, wherein the bearing facilitates rotation of the driving member relative to the housing and resists axial movement of the driving member relative to the housing.

This application claims priority from U.S. Provisional Patent App. No. 60/641,407 filed on Jan. 5, 2005, the entire contents of which are incorporated herein by reference.

### BACKGROUND

The present application relates to electric park brake assemblies and, more particularly, to bearings for use in electric park brake assemblies and methods for reduced air entrapment within electric park brake assemblies.

A typical electric park brake assembly, generally designated 20 in FIG. 1, may include a brake caliper 30, a caliper housing 32, a transmission 74, a motor 70 and a plate 82. The caliper housing 32 may be connected to the plate 82 by fasteners 86, 88, the transmission 74 may be connected to the plate 82 by a fastener 76 and the motor 70 may be connected to the plate 82 by a fastener 72.

The caliper housing 32 may include a central bore 33 extending therethrough. A ball screw assembly 34 may be slidably received within the bore 33 and may define a hydraulic fluid chamber 38. The ball screw assembly 34 may include a screw member 42, a piston 36 and steel balls 48 positioned between the screw member 42 and the piston 36. The piston 36 may be hollow and may define the nut portion of the ball screw assembly 34, wherein rotation of the screw member 42 may be translated into distal advancement of the piston 36.

The piston 36 may include a generally helically grooved inner wall portion 40 and the screw member 42 may include a generally helically grooved outer wall portion 46. The screw member 42 may engage the piston 36 such that the grooved inner wall portion 40 is positioned adjacent to and along the grooved outer wall portion 46 to form a ball race. Steel balls 48 may be positioned in the ball race to reduce friction between the piston 36 and the screw member 42 when the screw member 42 rotates within the piston 36.

A driving member 50 may extend generally centrally through the caliper housing 32 and through an axial opening 64 in the closed end 66 of the caliper housing 32. If necessary, the driving member 50 may extend through an axial opening (not shown) in the plate 82. Driving member 50 may include an extended portion 52 that extends through and is closely received by an axial opening 44 in screw member 42. The extended portion 52 of drive member 50 may be generally non-round (e.g., square) in cross section such that rotation of the drive member 50 is translated into corresponding rotation of the screw member 42.

The drive member 50 may include a central bore 78 positioned opposite of the extended portion 52 (i.e., at the proximal end of the drive member 50). A drive shaft 51 extending from the transmission 74 may be closely received within the central bore 78 and may be connected to the driving member 50 by fasteners 56 such that rotational power from the motor 70 may be translated into rotation of the drive member 50.

A first seal 58, such as an O-ring or the like, may be positioned between the driving member 50 and the caliper housing 32 to prevent the loss of hydraulic fluid from the fluid chamber 38 between the driving member 50 and the caliper housing 32. A second seal 60, such as an O-ring or the like, may be positioned between the caliper housing 32 and the hollow piston 36 to prevent the loss of hydraulic fluid from the fluid chamber 38 between the hollow piston 36 and the caliper housing 32.

Electric park brake assemblies are further described in U.S. Pat. No. 6,550,598 to Drennen, the entire contents of which are incorporated herein by reference.

Thus, electric park brake assemblies may operate in a service or hydraulic brake mode and/or a park brake mode. In the hydraulic brake mode, hydraulic fluid from the master cylinder or an anti-lock braking system may fill the fluid chamber 38 and exert a linear force on the piston 36, thereby distally advancing the piston 36. In the park brake mode, the motor 70 may provide rotational force, by way of the transmission 74 and driving member 50, to the screw member 42, thereby distally advancing the piston 36.

Such park brake assemblies have presented several disadvantages. For example, air trapped within the assembly 20 may reduce the clamping force applied to the brake rotor (not shown). The grooved inner wall portion 40 of the piston 36 may facilitate the problem due to air becoming trapped in the grooves of the ball race. Furthermore, such assemblies may require two bearings 54, as described above, which may increase the material and/or manufacturing costs of the assembly.

Accordingly, there is a need for a method for reducing air entrapment in an electric park brake assembly. Furthermore, there is a need for an electric park brake having reduced material and/or manufacturing costs.

### SUMMARY

In one aspect, a brake apparatus is provided and includes a housing having a bore extending therethrough and an axial opening therein, a piston closely and slidably received within the bore, a driving member having a flange thereon, the driving member extending through the axial opening to operatively connected the piston to an electric motor, wherein rotation of the driving member is translated into axial movement of the piston, and a bearing coaxially received over the driving member and positioned between the flange and the housing, wherein the bearing facilitates rotation of the driving member relative to the housing and resists axial movement of the driving member relative to the housing.

In another aspect, a brake apparatus is provided and includes a housing having a bore extending therethrough and an axial opening therein, a piston positioned within the bore and moveable between at least a first position and a second position, a driving member extending through the axial opening to operatively connected the piston to an electric motor, wherein rotation of the driving member facilitates movement of the piston between the first and second positions, and a bearing positioned between the driving member and the housing, the bearing including at least one friction reducing device to facilitate rotation of the driving member relative to the housing, wherein the bearing is adapted to engage the driving member to prevent the driving member from moving proximally beyond a predetermined distance.

In another aspect, a method for assembling an electric park brake assembly is provided, wherein, the electric park brake assembly includes a piston having grooves and a screw member having grooves. The method includes the steps of applying a viscous material to at least one of the grooves of the piston and the grooves of the screw member, engaging the grooves of the piston with the grooves of the screw member to form a ball screw assembly and introducing a hydraulic fluid to the ball screw assembly.

Other aspects will become apparent from the following description, the accompanying drawings and the appended claims.

### BRIEF DESCRIPTION OF THE DRAWINGS

FIG. 1 is a front elevational view, in section, of a prior art electric park brake assembly;

FIG. 2 is a front elevational view, in section, of one aspect of a piston adapted for use in an electric park brake assembly;

FIG. 3 is a front elevational view, in section, of one aspect of a screw member adapted for use in an electric park brake assembly;

FIG. 4 is a front elevational view, in section, of one aspect of a ball screw assembly including the piston of FIG. 2 and the screw member of FIG. 3;

FIG. 5A is a front elevational view of one aspect of a bearing adapted for use in an electric park brake assembly;

FIG. 5B is a top plan view of the bearing of FIG. 5A; and

FIG. 6 is a front elevational view, partially in section, of an electric park brake assembly incorporating the bearing of FIG. 5A;

### DETAILED DESCRIPTION

It has been discovered that air entrapment may be reduced or eliminated by filling the grooves of the inner wall 40 of the piston 36 and/or the grooves of the outer wall 46 of the screw member 42 with a grease or other highly viscous material prior to assembly of the piston 36 and the screw member 42 (i.e., prior to assembly of the ball screw assembly 34).

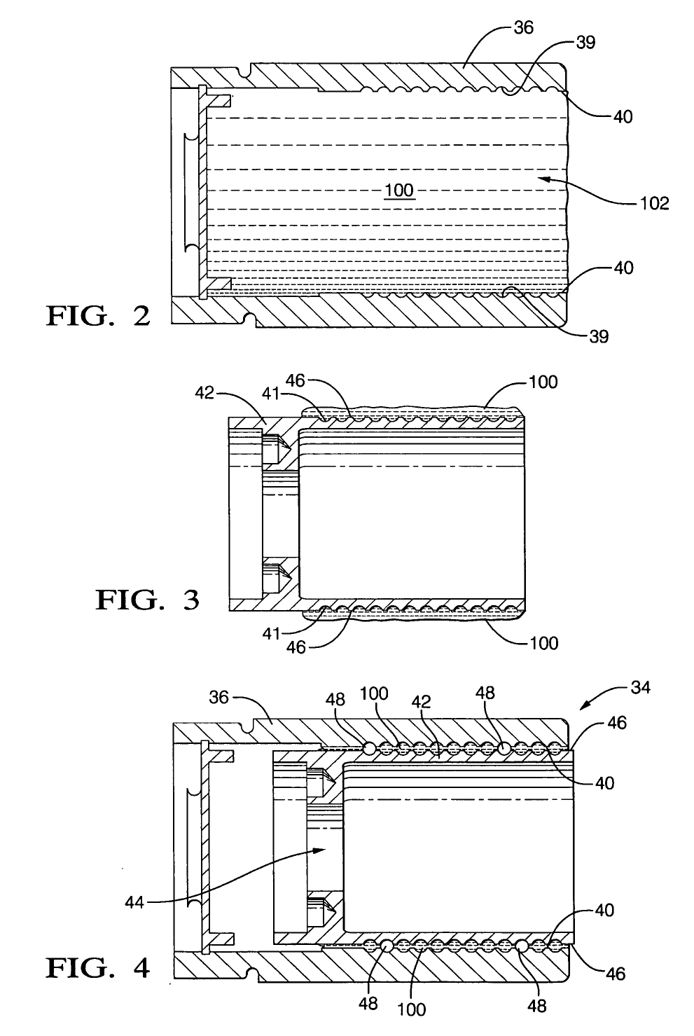

As shown in FIG. 2, during assembly of an electric park brake assembly, the piston 36 may be filled with a viscous material 100, such as a grease. The viscous material 100 may displace most (if not all) of the air in the grooves 39 of the grooved inner wall portion 40, thereby eliminating the problems associated with trapped air when hydraulic fluid is introduced to the system. Furthermore, the viscous material 100 may provide additional lubrication to the ball screw assembly 34.

In one aspect, the viscous material 100 may entirely fill the internal cavity 102 of the piston 36, as shown in FIG. 2. Alternatively, the viscous material 100 may be applied directly to the inner wall portion 40 of the piston 36, without filling the entire internal cavity 102.

As shown in FIG. 3, the grooves 41 of the grooved outer wall portion 46 of the screw member 42 may also be filled with a viscous material 100, thereby displacing the air from the grooves 41. Therefore, viscous material 100 may be applied to the grooves 39 of the piston 36, the grooves 41 of the screw member 42 or both.

The viscous material 100 may be any type of grease or highly viscous oil that is compatible with the hydraulic braking fluid used in the electric park brake assembly 20. In one aspect, the viscous material 100 may be a natural or petroleum-based grease. In another aspect, the viscous material 100 may be a synthetic grease.

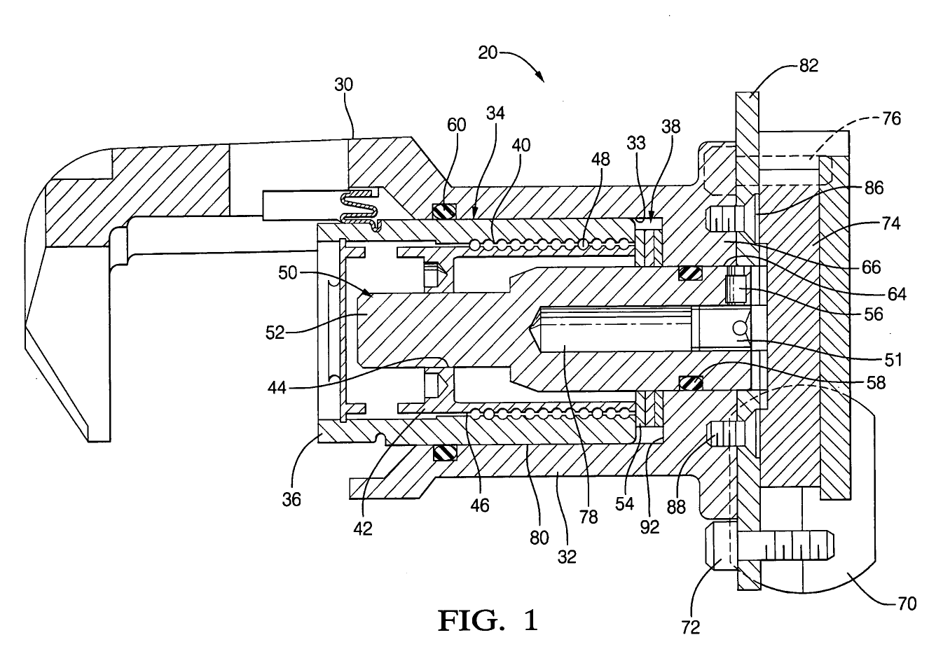

Accordingly, as shown in FIG. 4, when the screw member 42 is threaded into the piston 36 and positioned in an electric park brake assembly, such as the assembly 20 illustrated in FIG. 1, the viscous material 100 fills the grooves 39, 41 in the piston 36 and screw member 42, thereby preventing air from becoming trapped within the grooves 39, 41 when hydraulic fluid is introduced into the assembly.

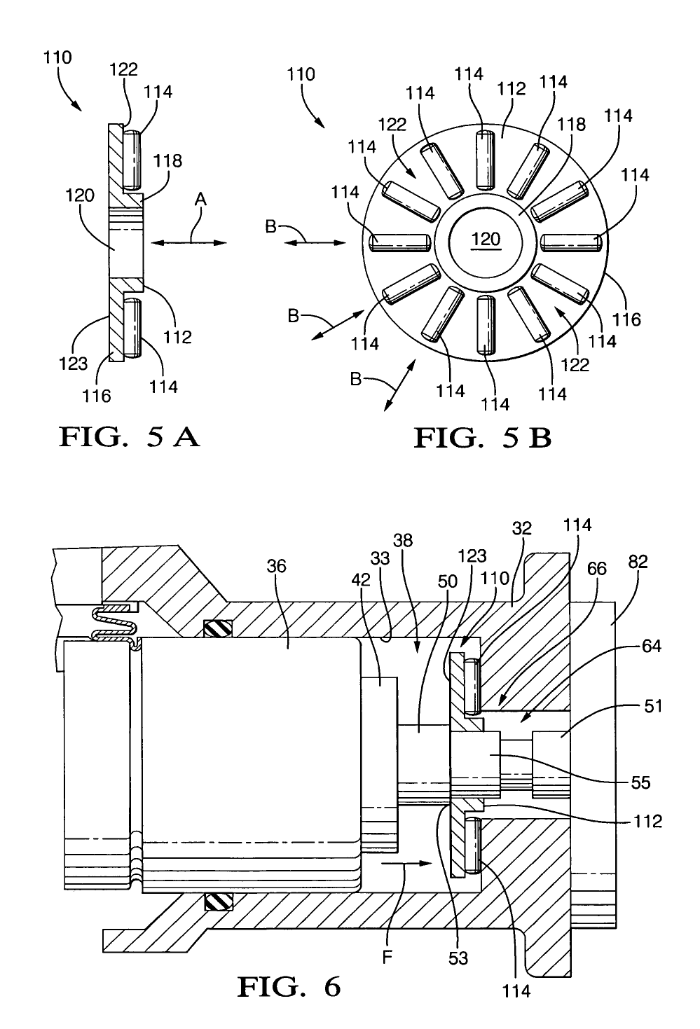

As shown in FIGS. 5A, 5B and 6, a dual load bearing for an electric park brake assembly, generally designated 110, may include a washer 112 and a plurality of needle rollers 114. The washer 112 may include a relatively large diameter portion 116 connected to and coaxially aligned with a relatively small diameter portion 118. The large diameter portion 116 of the washer 112 may have a larger diameter than the axial opening 64 in the closed end 66 of the caliper housing 32, as shown in FIG. 6. A central opening 120 may extends coaxially (i.e., along central axis A) through the center of the large 116 and small 118 diameter portions.

The needle rollers 114 may be distributed, equidistantly or randomly, about the periphery of the washer 112 and may be oriented generally radially with respect to the central axis A of the washer 112. The needle rollers 114 may be substantially cylindrical in shape. In one aspect, the needle rollers 114 may have a diameter of less than about 1/4 inch. In another aspect, the length of the needle rollers 114 may be about 3 to about 10 times the diameter of the needle rollers 114.

As shown in FIG. 5B, the needle rollers 114 may be distributed on a proximal surface 122 of the large diameter portion 116 of the washer 112. In one aspect, the proximal surface 122 may include indented recesses sized and shaped to closely receive the needle rollers 114 therein, thereby retaining the needle rollers 114 in the position shown in FIG. 5B, while allowing the needle rollers 114 to rotate about their respective longitudinal axes B.

At this point, those skilled in the art will appreciate that needle rollers 114 may be replaced with any device or apparatus capable of reducing the friction between the washer 112 and the caliper housing 32 when the friction reducing device is positioned between the washer 112 and the caliper housing 32. In one aspect, the friction reducing device may move independently of the washer 112 and/or the caliper housing 32. For example, needle rollers 114 may be replaced with ball bearings, rotating wheels or drums, floating pins or the like.

As shown in FIG. 6, the bearing 110 may be coaxially received over the driving member 50 such that a flanged portion 53 of the driving member 50 engages and is stopped by a distal surface 123 of the washer 112, while allowing a smaller diameter portion 55 of the driving member 50 to extend through the central opening 120 of the washer 112. The smaller diameter portion 55 of the driving member 50 may mate with, or engage, the transmission or motor of the electric park brake assembly.

The needle rollers 114 may be positioned between the proximal surface 122 of the washer 112 and the caliper housing 32, thereby allowing the drive member 50 to easily rotate (i.e., rotate with reduced friction) relative to the caliper housing 32 during, for example, the park brake mode, while preventing the driving member 50 from moving in the proximal direction (i.e., the direction shown by arrow F) when a force is applied to the driving member 50 in the direction of arrow F (e.g., during the hydraulic brake mode or a combination of hydraulic and park brake modes). Therefore, the forces applied to the piston 36 by the ball screw assembly 34 may be resisted by the bearing 110, thereby urging the piston 36 in the distal (i.e., rotor engaging) direction.

Accordingly, a single bearing 1 10 may be used to both (1) reduce the friction resulting from rotation of the drive member 50 relative to the caliper housing and (2) resist the forces generated when the piston is advanced to the rotor engaging position.

Although various aspects have been shown and described, modifications may occur to those skilled in the art upon reading the specification. The public is hereby placed on notice that any patent that may issue on this application includes such modifications and is limited only by the scope of the claims.

What is claimed is:

1. A brake apparatus operable by an electric motor, said apparatus comprising:
a housing having a bore extending therethrough and an axial opening therein;
a piston closely and slidably received within said bore;
a driving member having a flange thereon, said driving member extending through said axial opening to operatively connect said piston to said electric motor, wherein rotation of said driving member is translated into axial movement of said piston; and
a bearing coaxially received over said driving member and positioned between said flange and said housing, wherein said bearing facilitates rotation of said driving member relative to said housing and resists axial movement of said driving member relative to said housing.

2. The apparatus of claim 1 wherein said bearing resists axial movement of said driving member relative to said housing in a direction away from said piston.

3. The apparatus of claim 1 further comprising a screw member for translating said rotation of said driving member into axial movement of said piston.

4. The apparatus of claim 1 wherein said piston and said housing define a fluid chamber therebetween and said piston is adapted to move axially in response to fluid pressure in said fluid chamber.

5. The apparatus of claim 1 wherein said bearing is positioned over said axial opening and is generally larger than said axial opening.

6. The apparatus of claim 1 wherein said bearing includes at least one friction reducing device to facilitate rotation of said driving member relative to said housing.

7. The apparatus of claim 6 wherein said friction reducing device is a needle roller.

8. The apparatus of claim 1 wherein said driving member includes a first portion and a second portion, wherein said first portion extends through said bearing and said flange prevents said second portion from extending through said bearing.

9. The apparatus of claim 1 wherein said bearing includes a washer having a plurality of needle rollers disposed thereon.

10. The apparatus of claim 9 wherein said needle rollers have a diameter and a length, wherein said length is about 3 to about 10 times said diameter.

11. A brake apparatus operable by an electric motor, said apparatus comprising:
a housing having a bore extending therethrough and an axial opening therein;
a piston positioned within said bore and moveable between at least a first position and a second position;
a driving member extending through said axial opening to operatively connect said piston to said electric motor, wherein rotation of said driving member facilitates movement of said piston between said first and second positions; and
a bearing positioned between said driving member and said housing, said bearing including at least one friction reducing device adapted to facilitate rotation of said driving member relative to said housing, wherein said bearing is adapted to engage said driving member to prevent said driving member from moving proximally beyond a predetermined distance.

12. The apparatus of claim 11 wherein said piston and said housing define a fluid chamber therebetween and said piston is adapted to move axially in response to fluid pressure in said fluid chamber and rotation of said driving member.

13. The apparatus of claim 11 wherein said friction reducing device is a plurality of needle rollers.

14. The apparatus of claim 13 wherein said needle rollers have a diameter and a length, wherein said length is about 3 to about 10 times said diameter.

15. The apparatus of claim 1 1 wherein said bearing includes a washer and said friction reducing device is positioned between said washer and said housing.

16. A method for assembling an electric park brake assembly, said electric park brake assembly including a piston having grooves and a screw member having grooves, said method comprising the steps of:
applying a viscous material to at least one of said grooves of said piston and said grooves of said screw member;
engaging said grooves of said piston with said grooves of said screw member to form a ball screw assembly; and
introducing a hydraulic fluid to said ball screw assembly.

17. The method of claim 16 wherein said viscous material displaces air from at least one of said grooves of said piston and said grooves of said screw member.

18. The method of claim 16 wherein said applying step includes substantially filling an internal cavity of said piston with said viscous material.

19. The method of claim 16 wherein said viscous materials includes at least one of a synthetic grease, a natural grease, a petroleum-based grease and a highly viscous oil.

20. The method of claim 16 wherein said viscous material is compatible with said hydraulic fluid.
